(19) United States
(12) Patent Application Publication
(10) Pub. No.: US 2015/0051837 A1
(43) Pub. Date: Feb. 19, 2015

(54) SYSTEM AND METHODS FOR RISK PREDICTION AND ASSESSMENT

(71) Applicant: Cornell University, Ithaca, NY (US)

(72) Inventors: Michael C. Kelley, Ithaca, NY (US); Wesley E. Swartz, Ithaca, NY (US)

(21) Appl. No.: 14/389,692

(22) PCT Filed: Apr. 4, 2013
(86) PCT No.: PCT/US13/35288

§ 371 Date: Sep. 30, 2014

Related U.S. Application Data
(60) Provisional application No. 61/620,253, filed on Apr. 4, 2012.

(51) Int. Cl. G01W 1/16; G01V 1/00; G01W 1/10

(52) U.S. Cl. CPC G01W 1/16; G01W 1/10; G01V 1/008
USPC 702/3

(57) ABSTRACT

A system and methods for predicting and assessing risk before an event occurs. More particularly, the present invention predicts and assesses risk such as the occurrence of an earthquake prior to the event by collecting and analyzing changes in Total Electron Content (“TEC”) in the ionosphere.

### CROSS-REFERENCE TO RELATED APPLICATIONS

The present application claims priority to U.S. Provisional Patent Application No. 61/620,253 filed Apr. 4, 2012, the disclosure of which is hereby incorporated by reference in its entirety.

### FIELD OF THE INVENTION

The present invention relates generally to predicting and assessing risk. More specifically, the present invention is directed to a system and methods configured to predict risk and assess risk prior to an event, for example, an earthquake. Although the present invention is discussed herein with respect to the prediction and risk assessment of earthquakes, it is analogous to other event predictions and risk assessments such as tornados, hurricanes, or even events including the collapse of an underground mine.

Certain risks may be predicted and assessed prior to the event occurring by collecting and analyzing measurements of the atmosphere taken by a Global Positioning System (“GPS”). Specifically, the GPS measurements pertain to the Total Electron Content (“TEC”) in the ionosphere.

### BACKGROUND OF THE INVENTION

For many years, the search for credible precursors to predict events such as earthquakes has generated considerable controversy. Specifically, controversy remains over the validity of precursors and their use in predicting events such as earthquakes. Precursors include anything that precedes and indicates, suggests, or announces something to come.

Many studies have been conducted related to the prediction of natural disasters such as earthquakes. Earthquakes are often caused by the rupture of geological fault lines between plates in the Earth's crust, but also may be caused by volcanic activity, landslides, mine blasts, and nuclear tests. The location of the ruptured fault line is called a hypocenter. The portion of the Earth's surface directly above the hypocenter is called the epicenter. Earthquakes are measured by assessing seismic waves—that are, waves of energy that travel through the layers of the earth—with a tool called a seismometer. A set of seismic waves is called “seismic activity”.

Large earthquakes—those having a high level of seismic activity—are among the most destructive of Earth's natural disasters. Earthquakes have taken an enormous toll on human lives and property over the years. If people know that an earthquake is likely to occur soon, they can take certain precautions or protect themselves and their property. Accordingly, certain systems for predicting the occurrence of an earthquake have been developed. Such known systems attempt to use measurements of the gravitational field, turbulence associated with a seismic event, measurements of natural low frequency radio signals, strange animal behavior, and release of radon which ionizes the atmosphere through its alpha decay and thereby disturbs the normal ionosphere. Certain of the known precursors are not reliable or not easily measurable.

Other known precursors are detectable right before or during an earthquake. For example, co-seismic geomagnetic field changes were present during the 2011 Tohoku earthquake in Honshu, Japan. Such precursors can be used to warn people about aftershocks, tsunamis, and other effects of earthquakes, but are not useful to give people sufficient warning to prepare for the earthquake itself.

As other example, while Detection of Electro-Magnetic Emissions Transmitted from Earthquake Regions (DEMETER) satellites can be launched to investigate ionospheric disturbances, specifically precursor effects on Very-Low Frequency (VLF) propagation, due to seismic and volcanic activity, an increase in DEMETER-measured densities can be explained by elevated levels of solar activity.

Clearly, there is a need for a reliable system and methods for detecting an earthquake precursor in a timely manner before the earthquake occurs and distributing warning information about any impending earthquakes. The present invention satisfies this demand.

### SUMMARY OF THE INVENTION

One line of research has led scientists to study the relationship between earthquakes and the Earth's ionosphere. The Earth's ionosphere is a part of the Earth's upper atmosphere. The ionosphere layer of the atmosphere is approximately 50 km to more than 1000 km of altitude and comprises portions of the mesosphere, thermosphere, and exosphere, each of which are also layers of the Earth's atmosphere. The ionosphere is defined by the existence of ions, which are atoms or molecules with a net electric charge due to the loss or gain of one or more electrons. Electrons are responsible for the negative charge of an atom. If a neutral atom (atom with no charge) gains an electron, the net charge of the atom will be negative. If a neutral atom loses an electron, the net charge of the atom will be positive.

In some instances, ultraviolet rays from the Sun cause an atom or a molecule in the atmosphere to lose an electron, and accordingly, become an ion. The process is called ionization. As the level of ultraviolet radiation increases, the level of ions in the ionosphere increases and vice versa. As a result of ionization, the ionosphere includes electrons and electrically charged atoms or molecules.

In addition to the Sun, there are other causes of variation of electron levels in the ionosphere. Certain embodiments of the present invention are directed to detecting variations of electron levels in the ionosphere and identifying correlations between such variations and the occurrence of an earthquake. The ionosphere is measured by determining the total electron content, also called “TEC”. By measuring TEC at various time points, standard levels of TEC may be identified. Then, the TEC measured right before an earthquake can be compared to standard levels of TEC. As a result of the comparison, a model for predicting earthquakes may be built. Subsequently, when a predictive model forecasts an earthquake, warning notifications may be distributed or published to people via a computer system or other communication channels.

More specifically, the changes in the ionosphere are likely based on large-scale electric field patterns that occur prior to earthquakes. In certain instances, the flow of conductive sea water across the Earth's magnetic field drives electrical currents that, in turn, cause changes in the magnetic field. The magnetic declination time series provides approximately 15-40 minute precursor as supported by data from stations located at latitudes near the fracture zone compared with data from stations located south of the fracture zone, which do not show a similar change.

TEC is measured between satellites and ground stations. Satellites are transmitters and include, for example, Global Positioning System (GPS) satellites. The term “ground station” refers to any receiver including a fixed receiver or moving receiver. A receiver may include a land platform, a vehicle receiver, a fixed sea-based platform, moving sea-based platform, a fixed and suspended mid-air platform, or a moving airborne platform.

TEC changes near the epicenter are accompanied by changes at the effective ionospheric penetration points hundreds of kilometers away from the epicenter. TEC increases when more ionospheric electrons are penetrated by the Global Positioning System (GPS) ray. Similarly, TEC decreases when fewer ionospheric electrons are penetrated by the GPS ray. Such changes are expected from a large-scale electric field which varies in sign as a function of distance from the epicenter. As an example, an electric field of only 0.5 mV/m near 100 km is large enough to create TEC variations of the observed magnitude when they map along the magnetic field to the main ionosphere. Signal delays are often found in the ionosphere due to the TEC along the path from the GPS satellite to ground station.

By using one or more of the thousands of ground stations currently existing world-wide, many measurements may be taken and a predictive model can be created based on TEC measurements of a quiet-time ionosphere. Deviations of the actual TEC behavior from this predictive model can lead to warnings of natural disasters such as earthquakes before they occur.

In certain embodiments of the present invention, ionospheric effects are examined close to the epicenter and the region immediately surrounding the epicenter, where a reversal of the electric field is expected. The increase in TEC at latitudes of the quake, together with simultaneous decreases in areas north and south of the quake area, suggest an electrodynamic effect where the perturbing electric field reverses direction over the latitudes of interest with a separation of hundreds of kilometers. Wavelengths this long correspond to frequencies in the Extremely Low Frequency (ELF) range. When changes are detected in the ionosphere, warnings can be sent to communicate preparation. For example, warnings can be sent to gas suppliers and State governments such that natural gas suppliers and pipelines could be shut down, people could leave buildings such as those near the epicenter, public safety officials, fire-fighters and police could prepare, and warning signals such as Tornado-like alarms could be broadcast.

Certain embodiments of the present invention are configured to solve at least one technical problem. One technical problem is how to reliably predict earthquakes. A technical solution to this technical problem includes creating a predictive model based on Total Electron Content measurements taken from a quiet-time ionosphere, comparing the Total Electron Content data to the predictive model, and forecasting an earthquake warning when the Total Electron Content data deviates from the predictive model.

The present invention and its attributes and advantages may be further understood and appreciated with reference to the detailed description below of one contemplated embodiment, taken in conjunction with the accompanying drawings.

### DESCRIPTION OF THE DRAWING

FIG. 1A illustrates a method embodiment of the present invention;

FIG. 1B illustrates another method embodiment of the present invention;

FIG. 2A illustrates an embodiment of a system for obtaining Total Electron Content (TEC) measurements according to the invention;

FIG. 2B illustrates another embodiment of a system for obtaining Total Electron Content (TEC) measurements according to the invention;

FIG. 3 is a graph illustrating a slant TEC time series from ten ground stations and satellite according to the present invention;

FIG. 4A is a graph illustrating ground tracks corresponding to the TEC time series of FIG. 3 from Satellite 15 according to the present invention;

FIG. 4B is a graph illustrating ground tracks corresponding to the TEC time series from Satellite 26 according to the present invention;

FIG. 5 illustrates electric field streamlines according to the present invention;

FIG. 6 is a schematic showing lift and lowering of the ionosphere with an electric field sign change according to the present invention;

FIG. 7 is an exemplary computer system according to the present invention; and

FIG. 8 is an exemplary cloud computing system according to the present invention.

### DETAILED DESCRIPTION OF THE INVENTION

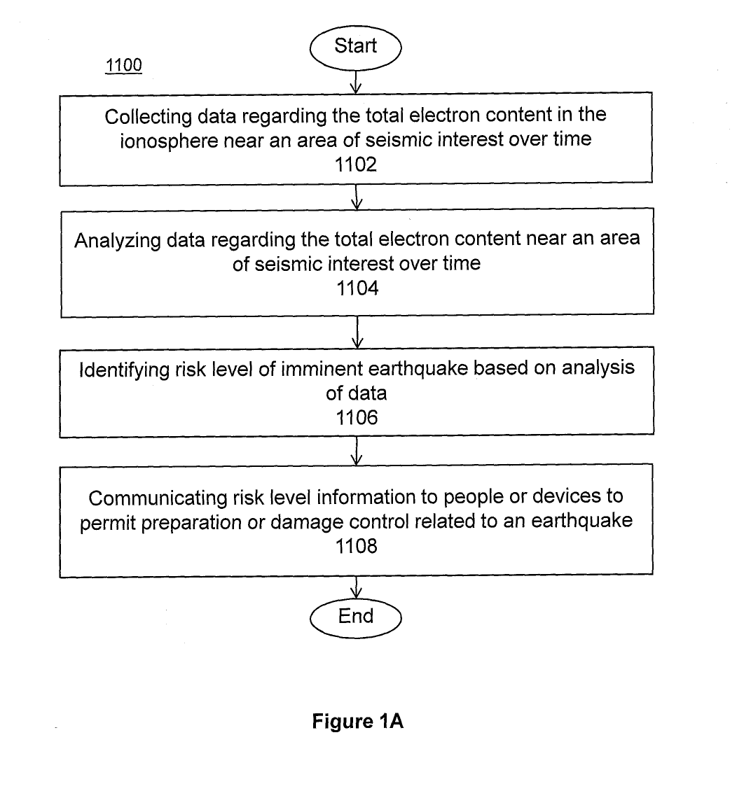

Certain embodiments of the invention are directed to a method for predicting earthquakes. As illustrated in FIG. 1A, an embodiment of a method 1100 may include collecting data regarding the total electron content (TEC) in the ionosphere near an area of seismic interest 1102. Such data is analyzed in light of ionosphere data obtained from earlier measurements of a standard (non-earthquake) ionosphere 1104. From the analysis, the system may identify a risk level regarding whether an earthquake is imminent or not 1106. The system also may communicate the risk level information to people or devices to permit preparation of damage control related to an earthquake 1108.

As illustrated in FIG. 1B, another embodiment of the present invention include a method 1100 for predicting an earthquake, comprising the steps of taking data generated from at least one satellite and a plurality of ground stations to measure Total Electron Content of an area of seismic interest for risk assessment 1112; determining variations in the Total Electron Content near the area of seismic interest and at two or more points located around the area of seismic interest to obtain Total Electron Content data 1113; creating a predictive model based on TEC measurements taken from a quiet-time ionosphere 1114; comparing the Total Electron Content data to the predictive model 1115; and forecasting an earthquake warning when the Total Electron Content data deviates from the predictive model 1116.

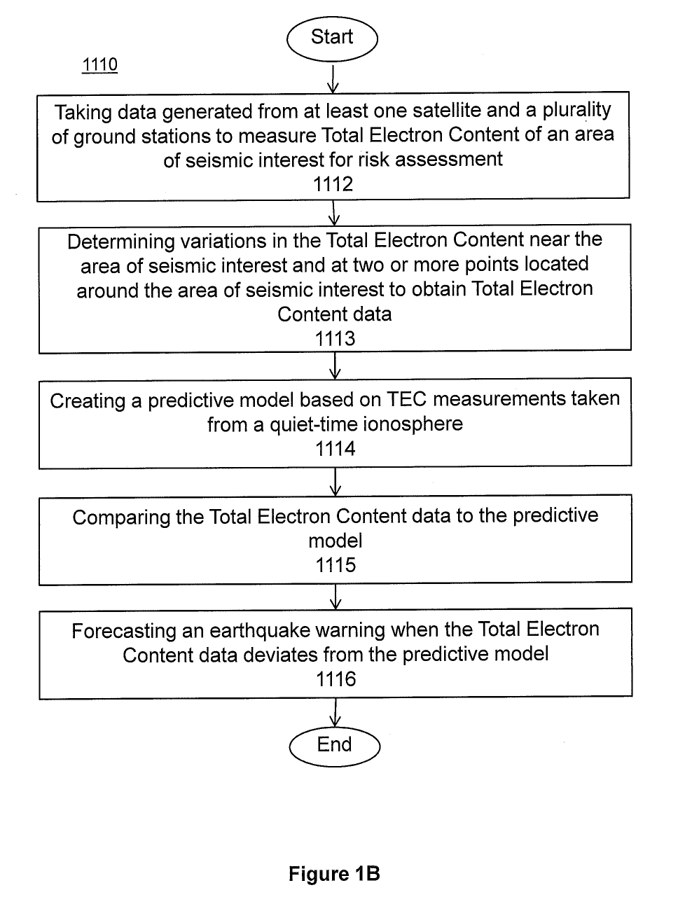

A system 1200 according to the present invention may be configured to measure the TEC in the Earth's ionosphere (or an atmospheric layer of another planet). As illustrated in FIG. 2A, an embodiment of the system 1120 may include a transmitter 1122 such as a satellite 1122A to send a signal 1123 to a receiver 1124. The signal 1123 may be a Global Positioning System (GPS) signal or another type of signal. The receiver 1124 may include a stationary receiver or a mobile receiver. A receiver 1124 may also be termed a “ground station”. Examples of a ground station include a land platform, a vehicle receiver, a fixed sea-based platform, moving sea-based platform, a fixed and suspended mid-air platform, or a moving airborne platform.

The TEC is measured by evaluating the amount of time it takes the signal 1123 to travel between the transmitter 1122 and the receiver 1124. Generally, the number of electrons is the parameter of the ionosphere that causes most of the effects on GPS signals. The time needed for the signal 1123 to cover the distance from the satellite 1122 to the receiver 1124 is found by integrating the velocity along the path, which depends on the integrated refractive index thereby providing the TEC expressed in electrons/m².

Certain embodiments of the present invention include a single or multiple transmitters 1122 and/or a single or multiple receivers 1124. For example, in one embodiment, a single transmitter 1122 will send one or more signals 1123 to each of two or more receivers 1124. in other embodiments, each of two or more transmitters 1122 will send one or more signals 1123 to a single receiver 1124. The data collected over time from each component 1122, 1124 permits calculating the total electron content at various geographic locations.

Once a set of TEC data is collected, the data may be analyzed using, for example, a computer system 1700 or a cloud computing system 1800 (described in more detail below) as illustrated in FIG. 2B. The analysis of the signal data permits determining a standard range of total electron content in the ionosphere. In addition, data regarding total electron content from a time period before an earthquake permits creating a predictive model. Using the predictive model and real-time or almost real-time data regarding the TEC from the ionosphere, the system may identify a risk level of an imminent earthquake. Such identification of risk may include forecasting an earthquake when the Total Electron Content data deviates from the predictive model. The risk level, whether high or low, may be communicated to people or devices to permit preparing for an earthquake optionally using a communication component. The communication component may include anything configured to communicate the risk level, including a computer system 1700 (as illustrated in FIG. 2B), cloud computing system 1800, network, intranet, Internet, telephone, facsimile, telegraph, or other communication method.

Certain embodiments of system components and method steps are described in more detail below. Certain of the satellites 1122 and ground stations 1124 are known by a particular numeric designation, however such designations are for reference only and not intended to be limiting. For example, such references include Satellite 15, Satellite 26, Ground station 8, Ground station 18, Ground station 38, Ground station 153, Ground station 165, Ground station 214, Ground station 226, Ground station 501, Ground station 602, and Ground station 5113.

Data from at least one satellite 1122 and a plurality of ground stations 1124 are taken to measure Total Electron Content of an area of seismic interest for risk assessment. In certain embodiments, 8 or more satellites 1122 are used to generate additional data. Variations in the Total Electron Content are determined near the area of seismic interest and at two or more points located around the area of seismic interest to obtain Total Electron Content data. A predictive model based on TEC measurements taken from a quiet-time (in other words, a standard ionosphere while no earthquake is imminent) ionosphere is created and the Total Electron Content data are compared to the predictive model. An earthquake warning is forecasted when the Total Electron Content data deviates from the predictive model.

The following is discussed with respect to the Mar. 11, 2001 Tohoku-Oki earthquake for illustration purposes only. It is contemplated that the features of the invention are equally applicable to other large earthquakes such as those measuring greater than 7.0 on the Richter scale.

According to the invention, ionospheric effects occur close to the epicenter and the region immediately surrounding the epicenter, where a reversal of the electric field is expected. The increase in TEC at latitudes of the quake, together with simultaneous decreases north and south of the quake area, suggest an electrodynamic effect where the perturbing electric field reverses direction over the latitudes of interest with a separation of hundreds of kilometers. Wavelengths this long correspond to frequencies in the Extremely Low Frequency (ELF) range.

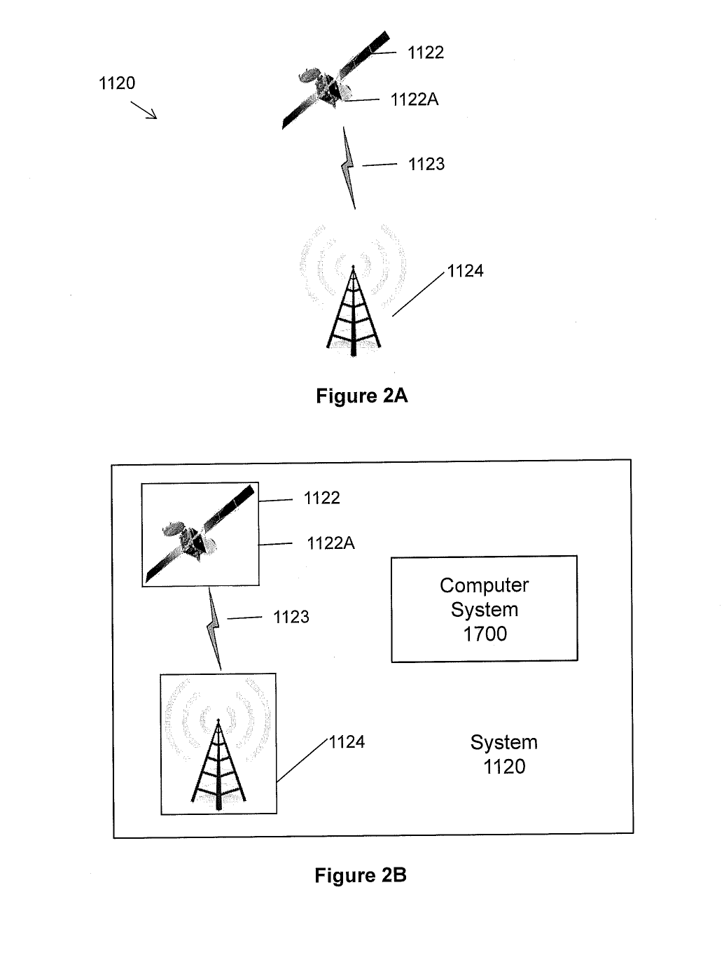

FIG. 3 is a graph 200 illustrating a slant TEC time series from ten ground stations and Satellite 15 according to the present invention. The ground station numbers 1201 are listed at the left of the curvature or track and the quake time is indicated by the vertical line 1203. An advantage of collecting data from a plurality of ground stations is that the data covers more latitudes. The graph 200 emphasizes times of TEC enhancement 1202 and TEC depression 1204. Specifically, TEC enhancement 1202 is illustrated above the track representing the ground station whereas TEC depression 1204 is illustrated below the track. Data is plotted from bottom to top and is collected from stations at increasing latitudes and with similar longitudes. As can been seen, ground stations 226, 214, 38, 165, 153, 18, and 8 all show steady growing TEC enhancement 1202, beginning about 40 minutes before the earthquake or a little after 5 UT hours.

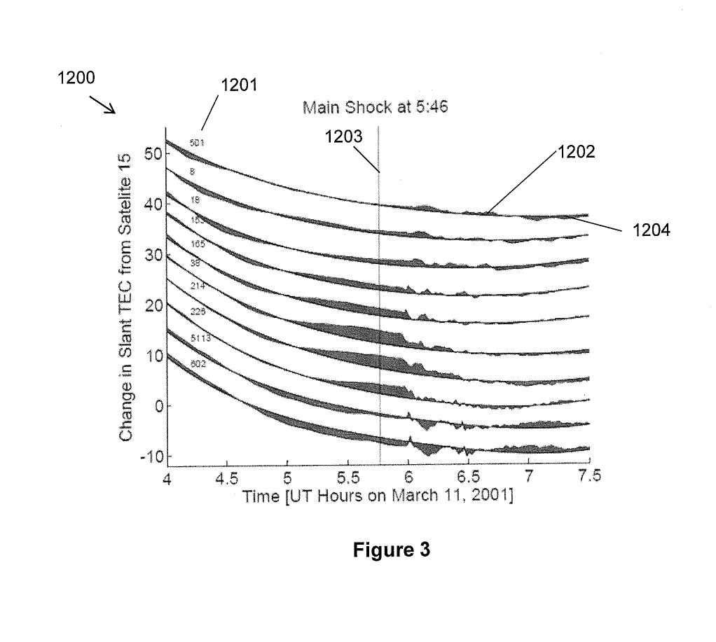

FIG. 4A is a graph illustrating ground tracks corresponding to the TEC time series of FIG. 3 from Satellite 15 according to the present invention. The ground station numbers 1301 are listed at the left of the track. Latitude versus longitude tracks of sub-ionospheric points (SIP) are plotted with TEC enhancements 1302 illustrated above the track representing the ground station and TEC depression 1304 illustrated below the track. The area fractured by the earthquake is depicted by the shaded box 1306 and the black dots 1303 show the location of SIPs at the time of the quake. As can be seen, the largest enhancements prior to the earthquake were at latitudes of the fractured area 306. However, along the two southernmost tracks illustrated by ground station number 602 and ground station number 5113, TEC was depressed prior to the quake.

FIG. 4B illustrates TEC variations along the SIPs from Satellite 26 for the same ground stations as used for Satellite 15 in FIG. 4A. The ground station numbers 1401 are listed at the left of the track. TEC enhancements 1402 are illustrated above the track and TEC depressions 1404 are illustrated below the track. The area fractured by the earthquake is depicted by the shaded box 1406 and the black dots 1403 show the location of SIPs at the time of the quake. Satellite 26 was east of Satellite 15 for the time period around the quake. FIG. 4B shows that, prior to the quake, TEC was enhanced over the fractured area 1406 and depressed north of the fractured area 1406.

Satellite 15, Satellite 26, and other GPS satellites near Japan all produced clear precursor deviations from the classic GPS/TEC U-shaped curve beginning 40 minutes to an hour before the Tohoku-Oki earthquake, which had a Moment Magnitude Scale (M_{W}) of 9.0. Precursors are apparent for quakes with M_{W}>8.2. There is a clear correlation between the magnitude of the deviation and the magnitude of the quake. Specifically, prior to earthquakes, TEC enhancements occur near the fracture area, whereas simultaneous decreases occur away from the fracture area.

If no measurements of the surface electric field near an earthquake are available, the ionospheric electric field needed at the base of the ionosphere (100 km altitude) to create the apparent TEC changes observed is determined. After the ionospheric electric field is determined, the corresponding ground-level electric field can be predicted.

TEC variations of ±10% may be generated by a 20-km upward or downward displacement of the main ionospheric layer. The variation may be caused by the line-of-sight GPS signals from a satellite to the ground alternatively going under the main layer (an apparent TEC decrease) or through the main layer (an apparent increase).

The 40 minute change observed requires a vertical velocity of about 8 m/s. This implies a 0.5-mV/m electric field to induce an \vec{E}×\vec{B}/\vec{B}² drift of 12 m/s with a 45° magnetic-field dip angle. This field only needs to reach the bottom of the ionosphere, since above that height, the conductivity parallel to the magnetic field maps the electric field with negligible change to 250 km.

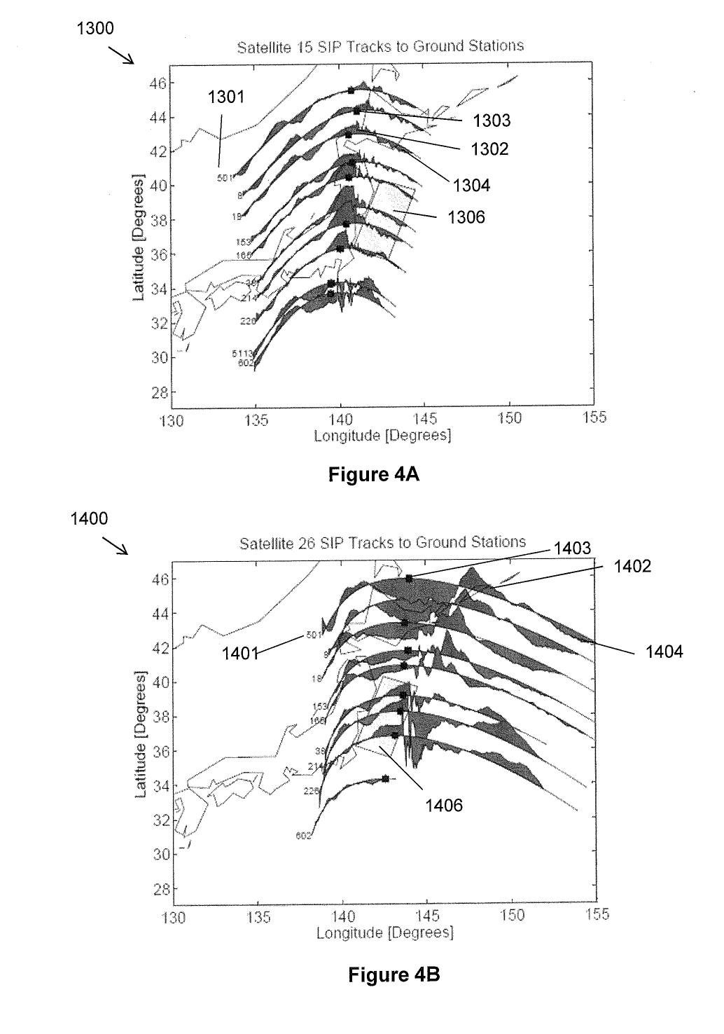

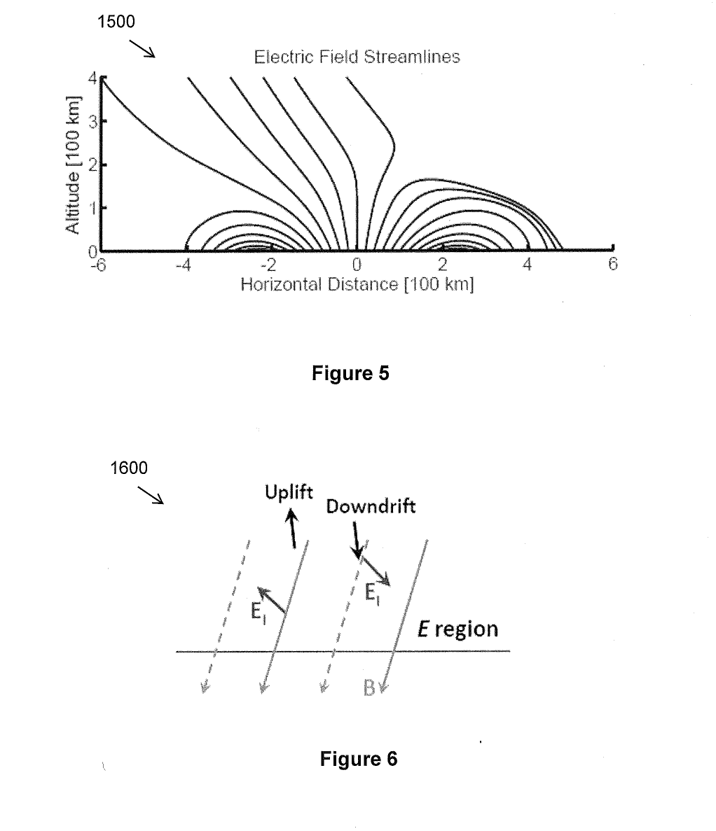

To predict the surface electric field required to generate the necessary 0.5 mV/m field at the base of the ionosphere, two models are considered: a charge dipole and a charged plate. The field of a charge dipole falls off as the cube of the distance, whereas the field of a charge plate falls off more slowly, depending on the size of the plate and the altitude above it. If the dipole were 10 km below the surface, the surface field would fall by as much as a factor of one thousand in reaching 100 km altitude. The field above a large charged plate (with respect to altitude) would appear something like the exaggerated model 1500 shown in FIG. 5. In the model 1500 illustrated in FIG. 5, the field only falls a factor of two or so. A smaller plate would produce a field that falls off faster. FIG. 5 shows how the electric field changes when the potentials map along the Earth's magnetic field above 100 km. Note that the field changes direction and weakens away from the center of the plate. A dipole and a plate represent two extremes of how fast the electric field would fall off with altitude from the surface to 100 km. FIG. 6 is a schematic showing lift and lowering of the ionosphere with an electric field sign change according to the present invention.

Considering the electric field just above a thunderstorm to be the value at 90 km required to generate red sprites, 200 V/m is needed for atmospheric breakdown. Just above the anvil cloud (the source of sprites), the field is 4×10⁴ V/m and the ratio is 200. The top of the anvil is very close to the surface for the distance scales of interest. Thus, at the surface a field of 0.1 V/m is needed to produce a field of 0.5 mV at the base of the ionosphere—this difference falling between the charge dipole model and the charged plate model. This is 1/1000 of the fair weather field and is difficult to measure. However, surface electric fields as small as 20 mV/m have actually been measured over an underground nuclear explosion. Large earthquakes create far greater disturbances than typical underground explosions. Accordingly, earthquake fields of any size should be measurable.

FIG. 6 shows a schematic 1600 of the reversing field geometry at ionospheric heights. This spatially varying electric field is responsible for the uplifts and downdrafts that lead to the apparent TEC changes around the epicenter, as shown in FIGS. 2-4.

TEC variations, both increases and decreases, precede large earthquakes. A mechanism such as conductivity changes, tribo- or piezo-electricity, creates charge separation prior to the quake with resultant electric fields over the epicenter region being directed differently than the surrounding region. The necessary electric field at the base of the ionosphere only needs to be 0.5 mV/m. Using the known properties of upward field mapping and the theory of red sprites, this corresponds to a 100 mV/m field near the surface. This is quite small and easily generated by the earthquake buildup, since it is known that magnetic fields are produced. The perturbations of the ionosphere created by these pre-seismic electric fields propagate outward, thereby explaining the early arrival of the waves in 630-nm airglow.

Certain embodiments of the present invention utilize a computer system 1700 or a cloud computing system 1800 for analyzing data, displaying graphical representations of data, and communicating earthquake prediction information to people or devices. Such embodiments may be configured to efficiently publish and distribute information about the likelihood of an earthquake. Such embodiments also may be configured to provide an automatic earthquake-preparation notification to devices under the control of the computer system.

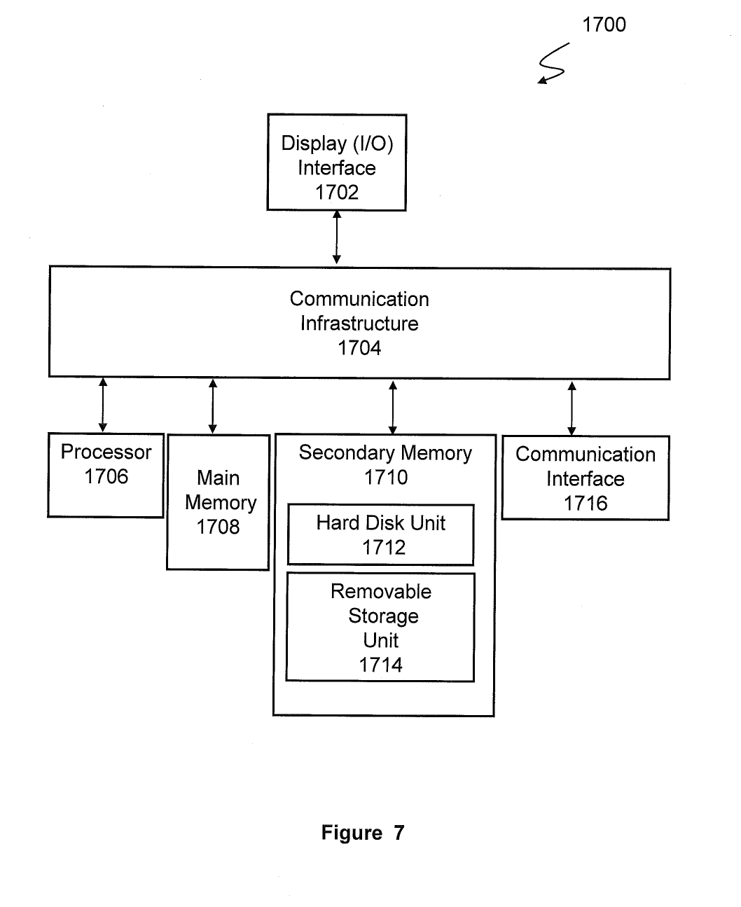

FIG. 7 illustrates an exemplary computer system 1700 that may be used to implement the methods according to the invention. One or more computer systems 1700 may carry out the methods presented herein as computer code.

Computer system 1700 includes an input/output display interface 1702 connected to communication infrastructure 1704—such as a bus—, which forwards data such as graphics, text, and information, from the communication infrastructure 1704 or from a frame buffer (not shown) to other components of the computer system 1700. The input/output display interface 1702 may be, for example, a keyboard, touch screen, joystick, trackball, mouse, monitor, speaker, printer, any other computer peripheral device, or any combination thereof, capable of entering and/or viewing data.

Computer system 1700 includes one or more processors 1706, which may be a special purpose or a general-purpose digital signal processor that processes certain information. Computer system 1700 also includes a main memory 1708, for example random access memory (“RAM”), read-only memory (“ROM”), mass storage device, or any combination thereof. Computer system 1700 may also include a secondary memory 1710 such as a hard disk unit 1712, a removable storage unit 1714, or any combination thereof. Computer system 1700 may also include a communication interface 1716, for example, a modem, a network interface (such as an Ethernet card or Ethernet cable), a communication port, a PCMCIA slot and card, wired or wireless systems (such as Wi-Fi, Bluetooth, Infrared), local area networks, wide area networks, intranets, etc.

It is contemplated that the main memory 1708, secondary memory 1710, communication interface 1716, or a combination thereof, function as a computer usable storage medium, otherwise referred to as a computer readable storage medium, to store and/or access computer software including computer instructions. For example, computer programs or other instructions may be loaded into the computer system 1700 such as through a removable storage device, for example, a floppy disk, ZIP disks, magnetic tape, portable flash drive, optical disk such as a CD or DVD or Blu-ray, Micro-Electro-Mechanical Systems (“MEMS”), nanotechnological apparatus. Specifically, computer software including computer instructions may be transferred from the removable storage unit 1714 or hard disc unit 1712 to the secondary memory 1710 or through the communication infrastructure 1704 to the main memory 1708 of the computer system 1700.

Communication interface 1716 allows software, instructions and data to be transferred between the computer system 1700 and external devices or external networks. Software, instructions, and/or data transferred by the communication interface 1716 are typically in the form of signals that may be electronic, electromagnetic, optical or other signals capable of being sent and received by the communication interface 1716. Signals may be sent and received using wire or cable, fiber optics, a phone line, a cellular phone link, a Radio Frequency (“RF”) link, wireless link, or other communication channels.

Computer programs, when executed, enable the computer system 1700, particularly the processor 1706, to implement the methods of the invention according to computer software including instructions.

The computer system 1700 described herein may perform any one of, or any combination of, the steps of any of the methods presented herein. It is also contemplated that the methods according to the invention may be performed automatically, or may be invoked by some form of manual intervention.

The computer system 1700 of FIG. 7 is provided only for purposes of illustration, such that the invention is not limited to this specific embodiment. It is appreciated that a person skilled in the relevant art knows how to program and implement the invention using any computer system.

The computer system 1700 may be a handheld device and include any small-sized computer device including, for example, a personal digital assistant (“PDA”), smart hand-held computing device, cellular telephone, or a laptop or netbook computer, hand held console or MP3 player, tablet, or similar hand held computer device, such as an iPad®, iPad Touch® or iPhone®.

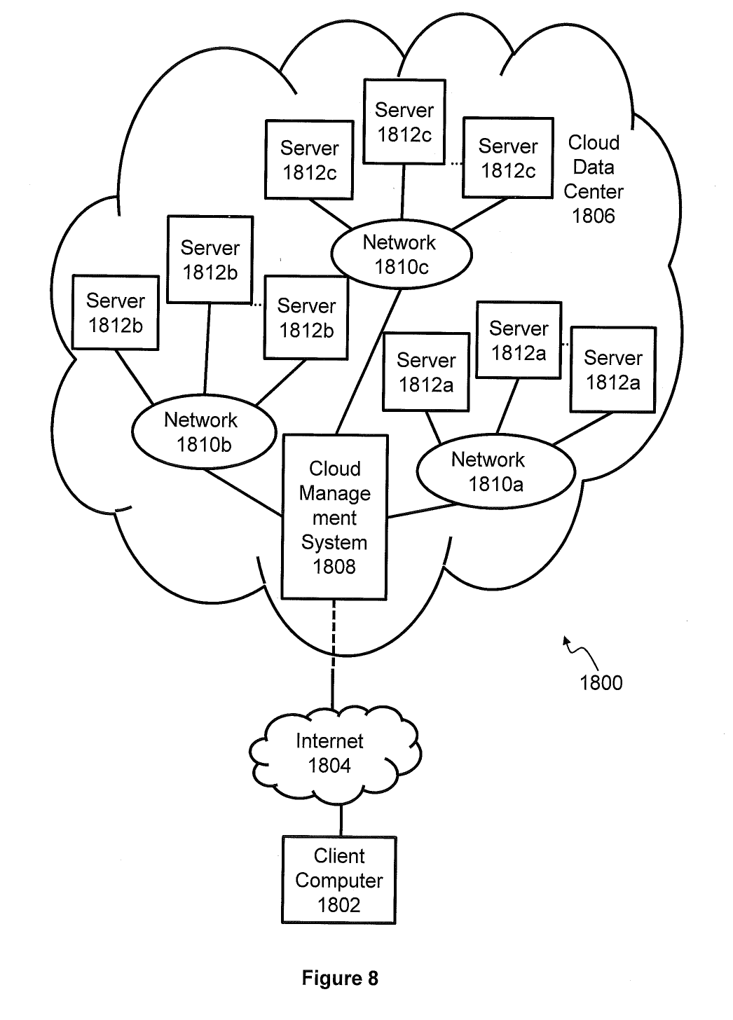

FIG. 8 illustrates an exemplary cloud computing system 1800 that may be used to implement the methods according to the present invention. The cloud computing system 1800 includes a plurality of interconnected computing environments. The cloud computing system 1800 utilizes the resources from various networks as a collective virtual computer, where the services and applications can run independently from a particular computer or server configuration making hardware less important.

Specifically, the cloud computing system 1800 includes at least one client computer 1802. The client computer 1802 may be any device through the use of which a distributed computing environment may be accessed to perform the methods disclosed herein, for example, a traditional computer, portable computer, mobile phone, personal digital assistant, tablet to name a few. The client computer 1802 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 1802 also includes a communications interface, for example, a modem, a network interface (such as an Ethernet card), a communications port, a PCMCIA slot and card, wired or wireless systems, etc. The communications interface allows communication through transferred signals between the client computer 1802 and external devices including networks such as the Internet 1804 and cloud data center 1806. Communication may be implemented using wireless or wired capability such as cable, fiber optics, a phone line, a cellular phone link, radio waves or other communication channels.

The client computer 1802 establishes communication with the Internet 1804—specifically to one or more servers—to, in turn, establish communication with one or more cloud data centers 1806. A cloud data center 1806 includes one or more networks 1810a, 1810b, 1810c managed through a cloud management system 1808. Each network 1810a, 1810b, 1810c includes resource servers 1812a, 1812b, 1812c, respectively. Servers 1812a, 1812b, 1812c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 1808 can comprise a dedicated or centralized server and/or other software, hardware, and network tools to communicate with one or more networks 1810a, 1810b, 1810c, such as the Internet or other public or private network, with all sets of resource servers 1812a, 1812b, 1812c. The cloud management system 1808 may be configured to query and identify the computing resources and components managed by the set of resource servers 1812a, 1812b, 1812c needed and available for use in the cloud data center 1806. Specifically, the cloud management system 1808 may be configured to identify the hardware resources and components such as type and amount of processing power, type and amount of memory, type and amount of storage, type and amount of network bandwidth and the like, of the set of resource servers 1812a, 1812b, 1812c needed and available for use in the cloud data center 1806. Likewise, the cloud management system 1808 can be configured to identify the software resources and components, such as type of Operating System (“OS”), application programs, and the like, of the set of resource servers 1812a, 1812b, 1812c needed and available for use in the cloud data center 1806.

The present invention is also directed to computer products, otherwise referred to as computer program products, to provide software to the cloud computing system 1800. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 1800 of FIG. 8 is provided only for purposes of illustration and does not limit the invention to this specific embodiment. It is appreciated that a person skilled in the relevant art knows how to program and implement the invention using any computer system or network architecture.

The described embodiments are to be considered in all respects only as illustrative and not restrictive, and the scope of the present invention is not limited to the foregoing description. Those of skill in the art may recognize changes, substitutions, adaptations and other modifications that may nonetheless come within the scope of the present invention and range of the present invention.

1. A method for predicting an earthquake, comprising the steps of:
taking data generated from at least one satellite and a plurality of ground stations to measure Total Electron Content of an area of seismic interest for risk assessment;
determining variations in the Total Electron Content near the area of seismic interest and at two or more points located around the area of seismic interest to obtain Total Electron Content data;
creating a predictive model based on TEC measurements taken from a quiet-time ionosphere;
comparing the Total Electron Content data to the predictive model; and
forecasting an earthquake warning when the Total Electron Content data deviates from the predictive model.

2. A method of predicting an earthquake using total electron content in Earth's ionosphere as a precursor, comprising the steps of:
collecting data regarding the total electron content in the ionosphere near an area of seismic interest over time;
analyzing collected data regarding the total electron content near an area of seismic interest over time;
identifying risk level of imminent earthquake based on analysis of data; and
communicating risk level information to people or devices to permit preparation or damage control related to an earthquake.
